(19) United States
(12) Patent Application Publication
(10) Pub. No.: US 2025/0227417 A1
(43) Pub. Date: Jul. 10, 2025

(54) RUBBER DIAPHRAGM, SOUND DEVICE AND APPLICATION THEREOF

(71) Applicant: AAC Microtech (Changzhou) Co., Ltd., Changzhou (CN)

(72) Inventors: Yuanwei Su, Changzhou (CN); Hongyuan Wang, Changzhou (CN); Hezhi Wang, Changzhou (CN); Chao Wang, Changzhou (CN)

(21) Appl. No.: 18/770,701

(22) Filed: Jul. 12, 2024

Related U.S. Application Data
(63) Continuation of application No. PCT/CN2024/071396, filed on Jan. 9, 2024.

(51) Int. Cl. H04R 7/02; C08K 11/00; H04R 9/02

(52) U.S. Cl. CPC H04R 7/02; C08K 11/00; H04R 9/025; H04R 2307/025

(57) ABSTRACT

Rubber diaphragm, sound device and application thereof are provided; rubber diaphragm includes distortion improving agent with mass percentage of 0.5-50%; distortion improving agent is random linear polymer with more than two monomer components randomly arranged on main chain, and distortion performance is synergistically regulated by monomer components; end group and/or side group and side chain of distortion improving agent includes special chemical reaction crosslinking points with mass percentage of 0.01-20, and number average molecular weight of distortion improving agent is 500-1200000; and distortion improving agent or main chain thereof is prepared by one-step method. Rubber diaphragm includes distortion improving agent, which is random linear polymer that components are randomly arranged on main chain. Sound device of rubber diaphragm is used to reduce distortion of low-frequency band obviously while maintaining good frequency response characteristics; and preparation method of distortion improving agent is simple, low in cost and has wide application.

### TECHNICAL FIELD

The disclosure relates to the technical field of new materials, in particular to a rubber diaphragm, a sound device and application thereof.

### BACKGROUND

With the rapid development of electronic technology and the improvement of people's living standards, consumers have more and more requirements on the sound quality of sound devices. Reducing the distortion (THD) of the sound device in a specific frequency band improves the sound quality of the sound device, which is more important for researchers. The diaphragm material serves as an important component of the sound device, and the THD of the sound device may be remarkably reduced by regulating the structure and performance of the material.

Rubber diaphragms are favored in the field of upper-class sound devices due to their own unique physical properties. How to improve the performance of the rubber diaphragm and reduce the THD of the sound device has attracted more and more attention.

Therefore, there is an urgent need in the prior art for a rubber diaphragm, so that the sound device equipped with the rubber diaphragm may not only keep the performance of the sound device basically unchanged, but also may significantly reduce the distortion of the low-frequency band, effectively improve the acoustic quality of the sound device, and at the same time has low production cost.

### SUMMARY

An object of the present disclosure is to provide a rubber diaphragm, a sound device and an application thereof, the rubber diaphragm includes a distortion improving agent, which may significantly improve distortion characteristics of a low-frequency sound device, and at the same time, the preparation method is simple, the production cost is low, and the application value is extremely high.

The technical solution of the present disclosure is as follows:

In a first aspect, the present disclosure provides a rubber diaphragm contains a distortion improving agent with a mass percentage of 0.5-50%; the distortion improving agent is a random linear polymer with more than two monomer components randomly arranged on a main chain, and the distortion performance is synergistically regulated by the monomer components; an end group and/or a side group, and a side chain of the distortion improving agent include special chemical reaction crosslinking point with a mass percentage of 0.01-20%, and a number average molecular weight of the distortion improving agent is 500-1200000; and the distortion improving agent or the main chain thereof is prepared by a one-step method.

As an improvement, the main chain of the distortion improving agent has a linear structure; the main chain is provided with one or more of the side groups or side chains, and the side chains include one or more of short branch chains or long branch chains.

As an improvement, the special chemical reaction crosslinking point includes one or more of a double bond, a triple bond, an epoxy group, a nitrile group, a siloxane, a carboxyl group, a hydroxyl group, an amide group, an amino group, an acyl chloride, an isocyanate group, a silicon-hydrogen bond, a Silicon-chloride bond, an azide group or an anhydride group.

As an improvement, the random linear polymer may be prepared by one of free radical polymerization, anionic polymerization, cationic polymerization or condensation polymerization.

As an improvement, the rubber diaphragm further includes main rubber, reinforcing filler, vulcanizing agent, vulcanization aid, anti-aging agent and release agent.

As an improvement, the preparation of the distortion improving agent specifically includes the following steps of:

weighing 100 parts by mass of styrene, 25-30 parts by mass of butadiene, 0.5-1 parts by mass of a cross-linking agent, 300 parts by mass of water and 5-10 parts by mass of an emulsifier; mixing above components to prepare an emulsion, adding 0.1-0.3 parts by mass of an initiator, 0.1-0.3 parts by mass of a polymerization terminating agent, 5-8 parts by mass of a polymerization regulator into the emulsion and introducing nitrogen for 20-30 min; and reacting for 1-5 h at 10° C. under the conditions of aeration and reflux condensation, and removing a solvent to obtain the distortion improving agent.

In a second aspect, the present disclosure provides a sound device, including a voice coil, a magnetic circuit system, a support structure, and the rubber diaphragm as described above.

In a third aspect, the present disclosure provides an application of the sound device in an end product.

The present disclosure has the following beneficial effects:

The present disclosure provides a rubber diaphragm, the rubber diaphragm includes a distortion improving agent, the distortion improving agent is a kind of random linear polymer macromolecular polymer of each component; when the rubber diaphragm is applied to a sound device, the distortion characteristic of the sound device may be remarkably reduced, and the original performance of the sound device may be kept; and the distortion improving agent is low in price and does not improve the overall production cost of the rubber diaphragm and the sound device.

### BRIEF DESCRIPTION OF DRAWINGS

FIG. 1 is a THD curve diagram of a rubber diaphragm obtained in the embodiment of the present disclosure and the rubber diaphragm applied to a sound device in the prior art.

### DESCRIPTION OF EMBODIMENTS

The present disclosure is further described below with reference to the accompanying drawings and embodiments.

To better illustrate the present disclosure, the present disclosure will be described in the following with reference to the accompanying drawings. Preferred embodiments of the present disclosure are shown in the drawings. However, the present disclosure can be embodied in many different manners and thus is not limited to the embodiments described herein. Rather, these embodiments are provided merely for better illustrating the present disclosure.

In a first aspect, the present disclosure provides a rubber diaphragm contains a distortion improving agent with a mass percentage of 0.5-50%; the distortion improving agent is a random linear polymer with more than two monomer components randomly arranged on a main chain, and the distortion performance is synergistically regulated between the monomer components; an end group and/or a side group of the distortion improving agent contain special chemical reaction crosslinking points with a mass percentage of 0.01-20% in the side chain, and a number average molecular weight of the distortion improving agent is 500-1200000; and the distortion improving agent or the main chain thereof is prepared by a one-step method, that is, the monomer is directly mixed to prepare the distortion improving agent or the main chain of the distortion improving agent in one step.

The rubber diaphragm of the present disclosure contains a distortion improving agent, the distortion improving agent is a random linear polymer with more than two monomer components randomly arranged on a main chain; polymers synthesized by different monomers have different damping temperature intervals, and the rubber diaphragm is applied to a sound device, so that the distortion characteristic of the sound device is remarkably reduced, and other performances of the sound device are not affected; and meanwhile, the raw material price of the distortion improving agent is low, and the overall production cost of the sound device and an end product is not improved at the production cost. When use the sound device containing the distortion improving agent rubber diaphragm, the THD of the sound device in the low-frequency band is obviously reduced, the sound quality is improved, and meanwhile, the sound device has almost no influence on F0 and frequency response. The sound device has been used in the fields of a mobile phone, an earphone, a tablet, a computer, an automobile, a television, a speaker, and the like.

As an improvement, the main chain of the distortion improving agent is a linear structure; the main chain carries one or more of the side groups or side chains, and the side chains include one or more of short branch chains or long branch chains; preferably, the main chain has 1-5 side groups.

As an improvement, the special chemical reaction crosslinking point includes one or more of a double bond, a triple bond, an epoxy group, a nitrile group, a siloxane, a carboxyl group, a hydroxyl group, an amide group, an amino group, an acyl chloride, an isocyanate group, a silicon-hydrogen bond, a Silicon-chloride bond, an azide group or an anhydride group.

As an improvement, the random linear polymer may be prepared by one of free radical polymerization, anionic polymerization, cationic polymerization or condensation polymerization.

As an improvement, the rubber diaphragm further includes main rubber, reinforcing filler, vulcanizing agent, vulcanization aid, anti-aging agent and release agent.

In some embodiments, by mass, the rubber diaphragm includes 100 parts by mass of ethylene acrylate elastomeric monomer Vamac G, 2 parts by mass of anti-aging agent Naugard 445, 1.5 parts by mass of release agent Armeen 18D, 1.5 parts by mass of release agent Vanfre VAM, 1.5 parts by mass of Stearic Acid, 50 parts by mass of AEM rubber Spheron SOA SO N-550, 1.5 parts by mass of vulcanizing agent DIAK NO.1, 2 parts by mass of vulcanization aid Vulcofac ACT55, and 10 parts by mass of the distortion improving agent.

As an improvement, the preparation of the distortion improving agent specifically includes the following steps of:

by mass, weighing 100 parts by mass of styrene, 25-30 parts by mass of butadiene, 0.5-1 parts by mass of a cross-linking agent, 300 parts by mass of water and 5-10 parts by mass of an emulsifier; mixing and preparing an emulsion by an emulsifier, adding 0.1-0.3 parts by mass of an initiator, 0.1-0.3 parts by mass of a polymerization terminating agent, 5-8 parts by mass of a polymerization regulator and introducing nitrogen for 20-30 min; and reacting for 1-5 h at 10° C. under the conditions of aeration and reflux condensation, and removing a solvent to obtain the distortion improving agent.

The present disclosure provides a sound device, including the rubber diaphragm, the voice coil, the magnetic circuit system and the support structure as described above.

In a third aspect, the present disclosure provides an application of the sound device in an end product. In some embodiments, the end product includes a mobile phone, a smart watch, a computer, a speaker, a television, an automobile, and the like.

Embodiment 1: preparation of distortion improving agent, including steps of:

100 parts by mass of styrene, 25 parts by mass of butadiene, 0.5 parts by mass of hydroxyethyl acrylate, 300 parts by mass of water and 5 parts by mass of emulsifier DNS-86 were weighed to prepare the emulsion by a emulsifier, 0.1 parts by mass of tert-butyl hydroperoxide, 0.1 parts by mass of ascorbic acid, 5 parts by mass of tert-dodecanethiol were added and nitrogen was introduced for 20 minutes; reacted for 1-5 hours at 10° C. under the conditions of aeration and reflux condensation, and the solvent was removed to obtain the required distortion improving agent, which is recorded as distortion improving agent 1. Hydroxyethyl acrylate is the crosslinking agent, tert-butyl hydroperoxide is the initiator, ascorbic acid is the polymerization terminating agent, and tert-dodecanethiol is the polymerization regulator.

Embodiment 2: preparation of distortion improving agent, including steps of:

100 parts by mass of styrene, 30 parts by mass of butadiene, 5 parts by mass of hydroxyethyl acrylate, 300 parts by mass of water and 5 parts by mass of emulsifier DNS-86 were weighed to prepare the emulsion by the emulsifier, 0.1 parts by mass of tert-butyl hydroperoxide, 0.1 parts by mass of ascorbic acid, 5 parts by mass of tert-dodecanethiol were added and nitrogen was introduced for 20 minutes; reacted for 1-5 hours at 10° C. under the conditions of aeration and reflux condensation, and the solvent was removed to obtain the required distortion improving agent, which is recorded as distortion improving agent 2. Hydroxyethyl acrylate is the crosslinking agent, tert-butyl hydroperoxide is the initiator, ascorbic acid is the polymerization terminating agent, and tert-dodecanethiol is the polymerization regulator.

Embodiment 3: preparation of distortion improving agent, including steps of:

100 parts by mass of styrene, 28 parts by mass of butadiene, 5 parts by mass of hydroxyethyl acrylate, 300 parts by mass of water and 5 parts by mass of emulsifier DNS-86 were weighed to prepare the emulsion by the emulsifier, 0.1 parts by mass of tert-butyl hydroperoxide, 0.1 parts by mass of ascorbic acid, 5 parts by mass of tert-dodecanethiol were added and nitrogen was introduced for 20 minutes; reacted for 1-5 hours at 10° C. under the conditions of aeration and reflux condensation, and the solvent was removed to obtain the required distortion improving agent, which is recorded as distortion improving agent 3. Hydroxyethyl acrylate is the crosslinking agent, tert-butyl hydroperoxide is the initiator, ascorbic acid is the polymerization terminating agent, and tert-dodecanethiol is the polymerization regulator.

Embodiment 4: take carboxyl-containing AEM rubber as an example to illustrate the effect of the distortion improving agent of the present disclosure in the rubber diaphragm of the present disclosure. It can be understood that the embodiments of the present disclosure are intended to better illustrate the patent, rather than limit the application scope thereof.

Specific operations include steps of: The distortion improving agents 1, 2 and 3 obtained in embodiments 1-3 were mixed with other raw materials respectively to obtain rubber compounds containing distortion improving agents 1, 2 and 3 respectively, and the rubber formula is shown in Table 1 below; preferably, by mass, the selected raw materials in the rubber formula of the embodiments of the present disclosure include the rubber diaphragm including ethylene acrylate elastic monomer Vamac G, anti-aging agent Naugard 445, release agent Armeen 18D, release agent Vanfre VAM, Stearic Acid, AEM rubber Spheron SOA SO N-550, vulcanizing agent DIAK NO.1, vulcanization aid Vulcofac ACT55, and distortion improving agents obtained in embodiments 1-3.

TABLE 1
Rubber Formulation

| | | Rubber containing | Rubber containing | Rubber containing |
|---|---|---|---|---|
| | | distortion improving | distortion improving | distortion improving |
| | prior art | agent 1 | agent 2 | agent 3 |
| Vamac G | 100 | 100 | 100 | 100 |
| Naugard 445 | 2 | 2 | 2 | 2 |
| Armeen 18D | 1.5 | 1.5 | 1.5 | 1.5 |
| Vanfre VAM | 1.5 | 1.5 | 1.5 | 1.5 |
| Stearic Acid | 1.5 | 1.5 | 1.5 | 1.5 |
| Spheron SOA | 50 | 50 | 50 | 50 |
| SO N-550 | | | | |
| DIAK NO. 1 | 1.5 | 1.5 | 1.5 | 1.5 |
| Vulcofac | 2 | 2 | 2 | 2 |
| ACT55 | | | | |
| Distortion | — | 10 | — | — |
| improving agent 1 | | | | |
| Distortion | — | — | 10 | — |
| improving agent 2 | | | | |
| Distortion | — | — | — | 10 |
| improving agent 3 | | | | |

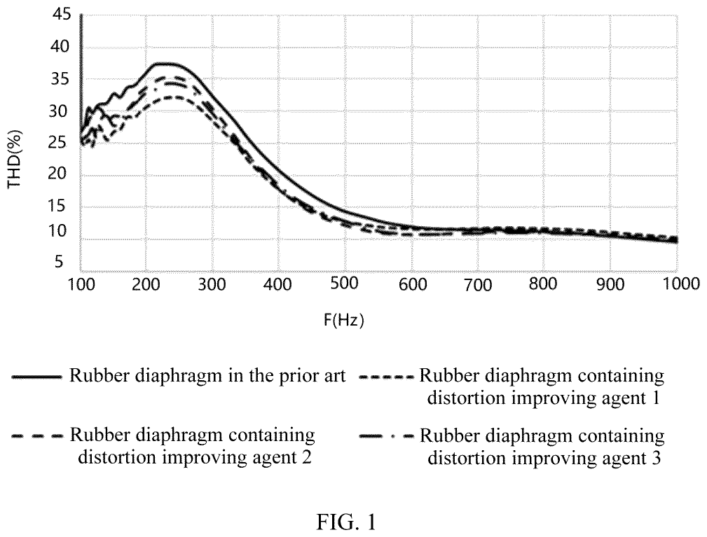

A rubber calender, a flat vulcanizing machine or a coating machine was used for pressing or coating the rubber compound into a sheet of about 100 microns, a diaphragm press was used to press at 200° C., 0.2 MPa and 10 min to obtain a rubber diaphragm, and the diaphragm was equipped to the speaker. Moreover, the rubber diaphragm in the prior art was used as a comparative example, the distortion (THD) performance of the speakers containing the distortion improving agents 1, 2 and 3 and the rubber diaphragm in the prior art was tested respectively, and the test results are shown in FIG. 1.

Referring to FIG. 1, the sound device equipped with the rubber diaphragm containing the distortion improving agent of the present disclosure has significantly reduced THD and improved sound quality at low-frequency band, and has almost no influence on F0 and frequency response. The sound device has been used in the fields of a mobile phone, an earphone, a tablet, a computer, an automobile, a television, a speaker, and the like.

The above description is only an embodiment of the present disclosure, and it should be noted that those skilled in the art may further make improvements without departing from the concept of the present disclosure, but these all fall within the protection scope of the present disclosure.

What is claimed is:

1. A rubber diaphragm, comprising: a distortion improving agent with a mass percentage of 0.5-50%; wherein
the distortion improving agent is a random linear polymer with more than two monomer components randomly arranged on a main chain, and distortion performance is synergistically regulated by the monomer components; an end group and/or a side group, and a side chain of the distortion improving agent comprises a special chemical reaction crosslinking point with a mass percentage of 0.01%-20%, and a number average molecular weight of the distortion improving agent is 500-1200000; and the distortion improving agent or the main chain thereof is prepared by a one-step method.

2. The rubber diaphragm as described in claim 1, wherein
the main chain of the distortion improving agent has a linear structure; the main chain is provided with one or more of the side group or side chain, and the side chain comprises one or more of a short branch chain or a long branch chain.

3. The rubber diaphragm as described in claim 1, wherein
the special chemical reaction crosslinking point comprises one or more of a double bond, a triple bond, an epoxy group, a nitrile group, a siloxane, a carboxyl group, a hydroxyl group, an amide group, an amino group, an acyl chloride, an isocyanate group, a silicon-hydrogen bond, a silicon-chloride bond, an azide group or an anhydride group.

4. The rubber diaphragm as described in claim 1, wherein
the random linear polymer is prepared by one of free radical polymerization, anionic polymerization, cationic polymerization or condensation polymerization.

5. The rubber diaphragm as described in claim 1, further comprising a main rubber, a reinforcing filler, a vulcanizing agent, a vulcanization aid, an anti-aging agent and a release agent.

6. The rubber diaphragm as described in claim 1, wherein preparation of the distortion improving agent comprises:
weighing 100 parts by mass of styrene, 25-30 parts by mass of butadiene, 0.5-1 parts by mass of a cross-linking agent, 300 parts by mass of water and 5-10 parts by mass of an emulsifier;
mixing above components to prepare an emulsion, adding 0.1-0.3 parts by mass of an initiator, 0.1-0.3 parts by mass of a polymerization terminating agent, 5-8 parts by mass of a polymerization regulator into the emulsion and introducing nitrogen for 20-30 min; and
reacting for 1-5 h at 10° C. under the conditions of aeration and reflux condensation, and removing a solvent to obtain the distortion improving agent.

7. A sound device, comprising: a voice coil, a magnetic circuit system, a support structure and a rubber diaphragm, wherein the rubber diaphragm comprises a distortion improving agent with a mass percentage of 0.5-50%; wherein
the distortion improving agent is a random linear polymer with more than two monomer components randomly arranged on a main chain, and distortion performance is synergistically regulated by the monomer components; an end group and/or a side group, and a side chain of the distortion improving agent comprises a special chemical reaction crosslinking point with a mass percentage of 0.01%-20%, and a number average molecular weight of the distortion improving agent is 500-1200000; and the distortion improving agent or the main chain thereof is prepared by a one-step method.

8. A use of the sound device as described in claim 7 in an end product.
